(19) United States
(12) Patent Application Publication
(10) Pub. No.: US 2021/0211202 A1
(43) Pub. Date: Jul. 8, 2021

(54) OPTICAL TRANSMITTER WITH MACH-ZEHNDER MODULATOR AND METHOD FOR OPERATING THE SAME

(71) Applicant: Oplink Communications, LLC, Fremont, CA (US)

(72) Inventors: Kuen-Ting TSAI, Tainan (TW); Zuon-Min CHUANG, Hsinchu (TW); Yao-Wen LIANG, Taoyuan (TW)

(73) Assignee: Oplink Communications, LLC, Fremont, CA (US)

(21) Appl. No.: 15/999,486

(22) PCT Filed: Dec. 2, 2016
(86) PCT No.: PCT/US2016/064729

§ 371 Date: Aug. 20, 2018

Related U.S. Application Data
(60) Provisional application No. 62/297,239, filed on Feb. 19, 2016.

(51) Int. Cl. H04B 10/50; H04B 10/54; H04B 10/58

(52) U.S. Cl. CPC H04B 10/50575; H04B 10/58; H04B 10/54

(57) ABSTRACT

The present disclosure provides a dither-free bias control of an optical modulator (OM) for the externally-modulated transmitter with the silicon-based Mach-Zehnder modulator (MZM), while the nonlinear distortions (NLDs) are generated by the plasma dispersion effect of the silicon-based MZM. The present disclosure proposes to intentionally offset the bias point of the MZM from its quadrature points, and therefore the Mach-Zehnder interference (MZI)-induced even-order NLDs can be generated to cancel the plasma dispersion-induced even-order NLDs. In addition, the MZM bias control is also proposed to arbitrarily adjust and lock in the bias point of an OM so a transmitter with the integrated MZM may reach the best even-order NLDs by offsetting from the quadrature points. Moreover, while the proposed scheme could arbitrarily adjust and lock in the bias of MZM, the receiver sensitivity may be optimized by using such a bias control scheme to adjust the extinction ratio of multi-level signals.

### RELATED APPLICATIONS

This patent application claims priority to U.S. Provisional Patent Application 62/297,239, entitled “DITHER-FREE BIAS CONTROL OF SILICON MZM-INTEGRATED OPTICAL TRANSMITTER,” which was filed on Feb. 19, 2016, and which is incorporated here by reference.

### DISCUSSION OF THE BACKGROUND

The present disclosure relates to an optical transmitter with a Mach-Zehnder modulator (MZM) and a method for operating the same, and more particularly, to a dither-free bias control of an MZM in an optical transmitter and a method for operating the same.

There has been a growing interest in the development of analog, amplitude modulated optical communication systems. In comparison to digital systems, analog communication systems provide an efficient use of bandwidth. This is particularly useful in cable television (CATV) transmission system applications, where it is necessary to transmit a large number of video channels through optical fibers. In addition, the ever-increasing demand for transmission capacity and a variety of limitations on spectral bandwidth in optical communication systems bring about the use of “spectrally efficient” modulation formats. Such modulation formats are generally based on higher-order optical modulation.

For the cable television (CATV) applications, the externally-modulated transmitters are used for transmission distances longer than 30 km so that the system performance will not be limited by the nonlinear distortions (NLDs) generated from the interaction of fiber chromatic dispersion and Laser chirp. Although an increasing number of analog channels needing higher signal fidelity are reclaimed and replaced by digital quadrature amplitude modulation (QAM) channels, the system signal-to-noise ratio (SNR) requirement is not reduced accordingly. Higher-order QAM signals of up to 4096-QAM were proposed so as to increase the spectrum utilization by the latest DOCSIS 3.1 standard, and therefore a link performance with better SNR is necessary to support higher-order modulation formats. For example, the requested electrical back-to-back SNR is 34 dB for DOCSIS 3.1 4096-QAM signals, while it is 28 dB for DOCSIS 3.0 256-QAM signals. Usually, the requested SNR of an optical link is around 10 dB higher than the electrical back-to-back requirement. In other words, SNR of ˜44 dB is desired for an optical link supporting 4096-QAM transmission.

Despite not having a laser chirp, the optical intensity modulator, such as an LiNbO3-based MZM, limits the SNR due to NLDs coming from the nonlinearity of the modulator's own transfer function. As shown in FIG. 1, the prior art uses the 3rd-order predistortion circuit between the applied modulation signal and the LiNbO3-based MZM to suppress 3rd-order NLDs (also known as composite triple beat (CTB) in the CATV industry). At the same time, the LiNbO3-based MZM is biased at its quadrature points to suppress even-order NLDs (also known as composite second order (CSO) in the CATV industry) completely. Resultantly, the use of LiNbO3-based MZM in the CATV externally-modulated optical transmitter can meet the stringent distortion requirements by means of the predistortion circuit and LiNbO3-based MZM bias controller.

As for the high-speed optical transport for >100 Gb/s technology, the transmission distance is limited by the fiber chromatic dispersion (CD) and polarization mode dispersion (PMD) having an increase of data rates. While the CD and PMD compensation technologies used in long haul systems are not attractive for access networks, the advanced modulation formats with higher spectrum efficiency have been proposed and discussed for >100 Gb/s technology, such as discrete multi-tone (DMT) and 4-level pulse amplitude modulation (PAM4). Moreover, with the introduction of the advanced modulation formats, the reduced requirement of the component bandwidth helps meet the economic considerations for field deployment.

Many uniformly frequency-spaced subcarriers are used to transmit data in DMT technology, and the high-order quadrature amplitude modulation (QAM) signals are carried by each subcarrier. The QAM modulation order could be adjusted adaptively according to the available system SNR for each subcarrier. This arrangement is similar to the access technology used in DOCSIS 3.1 for CATV access networks, as mentioned above. However, compared to the larger nonlinearity tolerance for binary non-return-to-zero (NRZ) modulation formats, the DMT approach needs a highly linear system to maintain sufficient SNR (or accurately SNDR, signal-to-noise and distortion ratio). Although NLDs could be compensated by the digital signal processing (DSP) implementation of Volterra nonlinear filters, the use of linear components or operating the components in their maximum linear region helps reduce the power consumption of DSP.

Again, to prevent the NLDs generated by the interaction of fiber chromatic dispersion and Laser chirp, an optical intensity modulator is used to replace a direct modulation Laser (DML). However, attention should be taken on the operation of an optical intensity modulator to prevent NLDs (as known as SSII, subcarrier-to-subcarrier intermixing interferences, for DMT technology) from the modulator itself that could degrade the available SNDR.

The PAM4 modulation is half the baud rate of binary NRZ signals, and accordingly, this modulation format is also helpful for >100 Gb/s optical transport. While the spectrum efficiency is increased by adding additional signal levels, the signal level spacing in between is reduced by a factor of 3 compared to binary NRZ. Therefore, PAM4 is more susceptible to noise, and the increase of the requested SNR is the disadvantage of using PAM4 modulation. The linearity is also an important factor related to the eye opening, and one should carefully manage the optical intensity modulator nonlinearity-induced impact on PAM4 modulation.

FIG. 2A is an explanatory diagram illustrating the sinusoidal electrical-to-optical (FJO) transfer function of LiNbO3-based MZM between the applied modulating voltage and the modulated optical power together with the applied electrical PAM4 eye diagrams and the resultant output optical intensity changes. The output eye opening of multi-level PAM signals is subject to the linearity in the system. As shown in FIG. 2A, while the LiNbO3-based MZM is biased at the quadrature point (The hollow circle is the MZM bias point), the vertical height VH10 (eye-opening from level 1 to level 0) and VH32 (eye-opening from level 3 to level 2) are equal due to the sinusoidal symmetric property with respect to the quadrature point. However, the peak-to-peak signal swing is saturated by the nonlinearity of the transfer curve, and thus the vertical height VH21 (eye-opening from level 2 to level 1) in the linear region is larger than VH10 and VH32 in the saturation region. A predistortion circuit or middle level adjustment at digital-to-analog converter (DAC) in FIG. 1 may be needed before applying the modulating signal into the MZM so that an equal signal level spacing (i.e. VH21=VH10=VH32) could be achieved for the best available SNR.

FIG. 2B shows the eye diagram of PAM4 at the output of LiNb3-based MZM, which is biased below the half power point (normalized optical intensity of 0.5), and obviously, the applied signal swing is not within the best linear region. The asymmetric bias point leads to unequal vertical heights (i.e. VH32>VH10), and the maximum available SNR is degraded accordingly. The similar SNR degradation could be observed in FIG. 2C, which shows the eye diagram for biasing above the half power point. As a result, the operation principle of the LiNbO3-based MZM for DMT and PAM4 modulations is similar to that used for CATV applications. The LiNbO3-based MZM should be biased at the symmetric quadrature points (or half power points) to suppress even-order NLDs completely, and the predistortion is introduced to mitigate the residual odd-order NLDs. Consequently, the best available SNR could be achieved by the linearization schemes for the LiNbO3-based MZM.

Because of the broad bandwidth, low chirp, and the low optical insertion loss, the LiNbO3-based MZM has been used in externally-modulated transmitters for many years. The CW light entering the MZM is split into two optical paths. The optical phase shifts in both arms (or in one arm) are modulated by the applied electrical signals before two optical paths are combined and interfere with each other. The resultant optical intensity at the MZM output is a raised sine or raised cosine function of the phase difference between two arms, while the phase shift (and also the effective refractive index change of the waveguide) is proportional to the applied electrical signal into an LiNbO3 waveguide.

The Mach-Zehnder interferometer (MZI)-induced sinusoidal transfer function between the applied modulating voltage and the modulated optical power limits the linear performance of LiNbO3-based MZM transmitters, as shown in Equation (1). It is well-known that an LiNbO3-based MZM should be biased at its quadrature points of the sinusoidal transfer curve to minimize the even-order NLDs, as the operation principle of the LiNbO3-based MZM summarized briefly below. Details of the operation principle of the LiNbO3-based MZM are available in the article (W. I. Way, Broadband Hybrid Fiber/Coax Access System Technologies. San Diego, Calif., USA: Academic, 1998, chapter 7.), the entirety of which is herein incorporated by reference.

A type of commercially available LiNbO3-based MZM has two optical output ports by using, for example, an optical directional coupler as the output power combiner. The static transfer functions of a LiNbO3-based MZM at the output port and the complementary output port are given, respectively, by the following equations:

$$\begin{matrix}{P}_{out , +} ( t ) = \frac{{P}_{in} {L}_{a}}{2} \{ 1 + sin [ \frac{π}{{v}_{π}} {V}_{app} ( t ) + {Φ}_{0} ] \} & ( 1 ) \\ {P}_{out , -} ( t ) = \frac{{P}_{in} {L}_{a}}{2} \{ 1 - sin [ \frac{π}{{v}_{π}} {V}_{app} ( t ) + {Φ}_{0} ] \} & ( 2 )\end{matrix}$$

where P_{out,+}(t) and P_{out,-}(t) are the optical intensity of a LiNbO3-based MZM at the optical output port and the complementary optical output port, Pᵢₙ is the input power of the MZM from a CW Laser, Lₐ is the insertion loss of the MZM, Vₐₚₚ(t) is the applied electrical signal into the MZM, V_{π} is the half wave voltage for a 180 degree optical phase shift, and ϕ₀ is the static bias phase shift. Assume that the applied electrical signal comprises discrete multi-tone radio frequency (RF) signals and a DC bias voltage V_{DC} as follows:

Vₐₚₚ(t)=Σᵢ₌₁^{N}A sin(ωᵢt+θᵢ)+V_{DC} (3)

where A and ωᵢ are the amplitude and angular frequency of an i-th channel. From Equation (1), (3) and Bessel function expansion, the fundamental amplitude can be expressed as follows:

$$\frac{{P}_{in} {L}_{a}}{2} \{ 2 {{J}_{1} ( χ ) [ {J}_{0} ( χ ) ]}^{N - 1} cos ( \frac{π}{{V}_{π}} {V}_{DC} + {Φ}_{0} ) \} \qquad ( 4 )$$

The amplitude of second-order intermodulation distortion (IMD) at ωᵢ+ωⱼ can be expressed as follows:

$$\frac{{P}_{in} {L}_{a}}{2} \{ {{2 [ {J}_{1} ( χ ) ]}^{2} [ {J}_{0} ( χ ) ]}^{N - 2} sin ( \frac{π}{{V}_{π}} {V}_{DC} + {Φ}_{0} ) \} \qquad ( 5 )$$

where Jₙ is the n-th order Bessel function of the first kind. Accordingly, the amplitude of the 2nd-order IMD becomes zero, while the LiNbO3-based MZM is biased at the quadrature points as follows:

$$\frac{π}{{v}_{π}} {V}_{DC} + {Φ}_{0} = m π , where m ∈ interger \qquad ( 6 )$$

As a result, the present disclosure adjusts the DC bias voltage, V_{DC}, of the LiNbO3-based MZM to meet the condition of Equation (6) for minimizing the even-order NLDs.

FIG. 3A shows the normalized output intensity as a function of bias voltage V_{DC} normalized to V_{π}, given ϕ₀=0 to simplify analysis without loss of generality. The corresponding normalized fundamental power, MZI-induced 2nd-order IMD power, and 2nd-order IMD phase are shown in FIG. 3B, FIG. 3C, and FIG. 3D, respectively. It could be observed that the normalized optical intensity is 0.5 at quadrature points (i.e. half power points), while the 2nd-order IMD power is minimum (i.e. zero). When the bias point of the LiNbO3-based MZM is slightly offset from quadrature points, the MZI-induced 2nd-order IMD increases significantly. In addition, the phase of 2nd-order IMD could be changed (0 or 180 degrees) in a different direction of a bias offset.

Operating the MZM at the proper condition is necessary to keep the best SNR and/or eye opening. However, the device drift, operation temperature variation, component aging and other effects may result in operational deviation from the best MZM bias point. As a result, many control methods and apparatuses were proposed to maintain consistent operation of the MZM. The bias control schemes could be divided into two categories. One is the bias control with applying amplitude modulation (AM) dithering signals, and the other is the dither-free control scheme. Details of the bias control with applying amplitude modulation (AM) dithering signals are available in the publications of U.S. Pat. Nos. 5,208,817, 5,321,543, 5,343,324, 5,900,621, 6,392,779, 6,426,822, 6,539,038, 6,570,698, 6,687,451, 7,106,486, 7,184,671, 7,369,290, 7,561,810, 7,715,732, 8,532,499 and 8,543,010, and details of the dither-free control scheme are available in the publication of U.S. Pat. No. 7,916,377, the entirety of which are herein incorporated by reference.

In the bias control with applying amplitude modulation (AM) dithering signals, one (or few) low-frequency AM dithering tone(s) is applied into the DC bias port of the MZM. While the MZM is not biased correctly, the 2nd-order harmonic distortion (or intermodulation distortion) is generated. The 2nd-order NLD at the MZM output is detected, and multiplied by the 2nd-order harmonic of the applied dithering tone. The sign of this product shows the direction of bias deviation, while the amplitude of this product is the deviation from the best bias point. As a result, this bias control scheme can change the bias point continuously such that the best MZM operation could be maintained over various environmental effects.

However, the bias control with AM dithering signals needs complicated circuit implementation, which prohibits use in modern optical module design in terms of size and power consumption. In addition, this AM dithering signal is used for bias control only, and is an interference to the modulating signal. To suppress the AM dithering at the output of the MZM by using a phase modulator or CW Laser was proposed in the publication of U.S. Pat. No. 6,570,698, the entirety of which is herein incorporated by reference.

In the dither-free control scheme, an error signal may be generated by subtracting monitor photodiode signals from the optical taps on two output ports of the optical modulator. The bias point of the MZM may be adjusted by minimizing the error signal. However, the zero of this error signal occurs at the half power point, where the detected optical powers from two complementary output branches (including taps, monitor photodiodes and optical power detection circuits) are equal.

As with the distortion characteristics of the silicon-based MZM discussed above, to reach the minimum even-order NLDs, the bias point of the silicon-based MZM should be slightly offset from the half power points. This bias control method disclosed in the publication of U.S. Pat. No. 7,916,377 is not adapted in terms of the distortion performance, and thus a dither-free bias control scheme for an arbitrary bias point is preferred for silicon-based MZMs.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY

One aspect of the present disclosure provides a dither-free bias control of an MZM in an optical transmitter and a method for operating the same.

An optical transmitter according to this aspect of the present disclosure comprises a laser source to produce an optical carrier signal; an optical modulator to modulate an RF input signal onto the optical carrier signal and provide RF modulated optical signals on a first output and a second output; and a controlling module which takes into consideration a feedback signal to control the optical modulator operating substantially not at a quadrature point of a transfer characteristic of the optical modulator; wherein the controlling module generates the feedback signal while taking into consideration a first power level of the RF modulated optical signal on the first output, a second power level of the RF modulated optical signal on the second output, and a weighting difference between the first optical power level and the second power level.

In some embodiments, the controlling module generates the feedback signal by using an expression:

$$feedback signal ( t ) = \frac{{P}_{out , +} ( t ) - w \times {P}_{out , -} ( t )}{{P}_{out , +} ( t ) + {P}_{out , -} ( t )}$$

wherein P_{out,+}(t) represents the first power level, P_{out,-}(t) represents the second power level, and w represents a weighting factor.

In some embodiments, the controlling module generates the weighting factor by using an expression:

$$w ≅ \frac{1 + {Φ}_{total , minNLD}}{1 - {Φ}_{total , minNLD}}$$

wherein ϕ_{total,minNLD} represents a bias phase substantially having a minimum even-order nonlinear distortion.

In some embodiments, the controlling module generates the weighting difference while taking into consideration Mach-Zehnder interference-induced even-order nonlinear distortions and plasma dispersion-induced even-order nonlinear distortions.

In some embodiments, the controlling module controls a phase of the RF modulated optical signal propagating in the optical modulator via an electrode on the optical modulator.

In some embodiments, the controlling module controls a temperature of the optical modulator via a thermoelectric cooler controller.

In some embodiments, the controlling module controls a bias voltage of the optical modulator via an electrode on the optical modulator.

In some embodiments, the controlling module controls a wavelength of the optical carrier signal from the laser source.

In some embodiments, the controlling module controls a temperature of the laser source.

In some embodiments, the controlling module controls a bias current of the laser source.

In some embodiments, the optical modulator is a silicon-based dual-optical-output modulator with two power monitoring photodiodes that detect the first power level and the second power level via two directional couplers; wherein the optical modulator, the two power monitoring photodiodes and the two directional couplers are integrally formed on a single chip.

In some embodiments, the optical modulator is a silicon-based dual-optical-output modulator with a first power monitoring photodiode that detect the first power level via a directional coupler, and a second power monitoring photodiode that detect the second power level without using a directional coupler; wherein the optical modulator, the two power monitoring photodiodes and the directional couplers are integrally formed on a single chip.

Another aspect of the present disclosure provides a method for operating an optical transmitter, comprising the steps of: producing an optical carrier signal; modulating an RF input signal onto the optical carrier signal and providing RF modulated optical signals on a first output and a second output; generating a feedback signal while taking into consideration a first power level of the RF modulated optical signal on the first output, a second power level of the RF modulated optical signal on the second output, and a weighting difference between the first optical power level and the second power level; and controlling the optical modulator operating substantially not at a quadrature point of a transfer characteristic of the optical modulator while taking into consideration the feedback signal.

In some embodiments, the step of generating a feedback signal is performed by using an expression:

$$feedback signal ( t ) = \frac{{P}_{out , +} ( t ) - w \times {P}_{out , -} ( t )}{{P}_{out , +} ( t ) + {P}_{out , -} ( t )}$$

wherein P_{out,+}(t) represents the first power level, P_{out,-}(t) represents the second power level, and w represents a weighting factor.

In some embodiments, the weighting factor is set by using an expression:

$$w ≅ \frac{1 + {Φ}_{total , minNLD}}{1 - {Φ}_{total , minNLD}}$$

wherein ϕ_{total,minNLD} represents a bias phase substantially having a minimum even-order nonlinear distortion.

In some embodiments, the weighting difference is generated while taking into consideration Mach-Zehnder interference-induced even-order nonlinear distortions and plasma dispersion-induced even-order nonlinear distortions.

In some embodiments, the step of controlling the power of the RF modulated optical signal is performed to control a phase of the RF modulated optical signal propagating in the optical modulator.

In some embodiments, the step of controlling the optical modulator operating substantially not at a quadrature point is performed by controlling a temperature of the optical modulator.

In some embodiments, the step of controlling the optical modulator operating substantially not at a quadrature point is performed by controlling a bias voltage of the optical modulator.

In some embodiments, the step of controlling the optical modulator operating substantially not at a quadrature point is performed by controlling a wavelength of the optical carrier signal.

In some embodiments, the step of controlling the optical modulator operating substantially not at a quadrature point is performed by controlling a temperature of a laser source producing the optical carrier signal.

In some embodiments, the step of controlling the optical modulator operating substantially not at a quadrature point is performed by controlling a bias current of the laser source producing the optical carrier signal.

The present disclosure provides a dither-free bias control of the optical modulator for the externally-modulated transmitter with the silicon-based MZM, while the nonlinear distortions (NLDs) are generated by the plasma dispersion effect of the silicon-based MZM. The present disclosure proposes to slightly offset the bias point of the silicon-based MZM from its quadrature points, and therefore the Mach-Zehnder interference (MZI)-induced even-order NLDs can be generated to cancel the plasma dispersion-induced even-order NLDs.

In addition, the dither-free MZM bias control is also proposed to arbitrarily adjust and lock in the bias point of an optical modulator so that an optical transmitter with the integrated silicon-based MZM can reach the best even-order NLDs by offsetting from the quadrature points. This proposed dither-free MZM bias control scheme ensures the linear operation of an optical MZM for various legacy and potentially promising analog/digital optical transmission systems, such as CATV subcarrier multiplexed lightwave systems, radio-over-fiber applications, >100 Gb/s optical transport with discrete multi-tone (DMT) or 4-level pulse amplitude modulation (PAM4), and so on.

Moreover, while the proposed dither-free control scheme can arbitrarily adjust and lock in the bias of the MZM, the receiver sensitivity can be optimized by using such a bias control scheme to adjust the extinction ratio of multi-level signals, such as binary NRZ, PAM4, etc.

The foregoing has outlined rather broadly the features and technical advantages of the present disclosure in order that the detailed description of the disclosure that follows may be better understood. Additional features and advantages of the disclosure will be described hereinafter, which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a block diagram of an externally-modulated transmitter according to the prior art.

FIGS. 2A to 2C are eye diagrams of a PAM4 signal through a LiNbO3-based MZM biased at half power according to the prior art.

FIGS. 3A to 3D show normalized optical intensity, fundamental power, 2nd-order IMD power and phase at the output of a LiNbO3-based MZM as a function of normalized bias voltage according to the prior art.

FIG. 4 illustrates an optical transmitter in accordance with various embodiments of the present disclosure.

FIG. 5A shows the optical power intensity at the first output as a function of the bias phase in accordance with various embodiments of the present disclosure.

FIG. 5B is a close-up view of FIG. 5A.

FIG. 6A shows the optical power intensity at the second output as a function of the bias phase in accordance with various embodiments of the present disclosure.

FIG. 6B is a close-up view of FIG. 6A.

FIG. 7A shows the corresponding error signal of the proposed bias control for the positive EO slopes of the output port in accordance with various embodiments of the present disclosure.

FIG. 7B is a close-up view of FIG. 7A.

FIG. 8A is the corresponding error signal of the proposed bias control for the negative EJO slopes of the output port in accordance with various embodiments of the present disclosure.

FIG. 8B is a close-up view of FIG. 8A.

FIG. 9A and FIG. 10A are the measured optical intensity, CSO and CTB as a function of the bias phase in accordance with various embodiments of the present disclosure.

FIG. 9B and FIG. 10B are close-up views of FIG. 9A and FIG. 10A, respectively.

FIG. 11 illustrates an optical transmitter in accordance with various embodiments of the present disclosure.

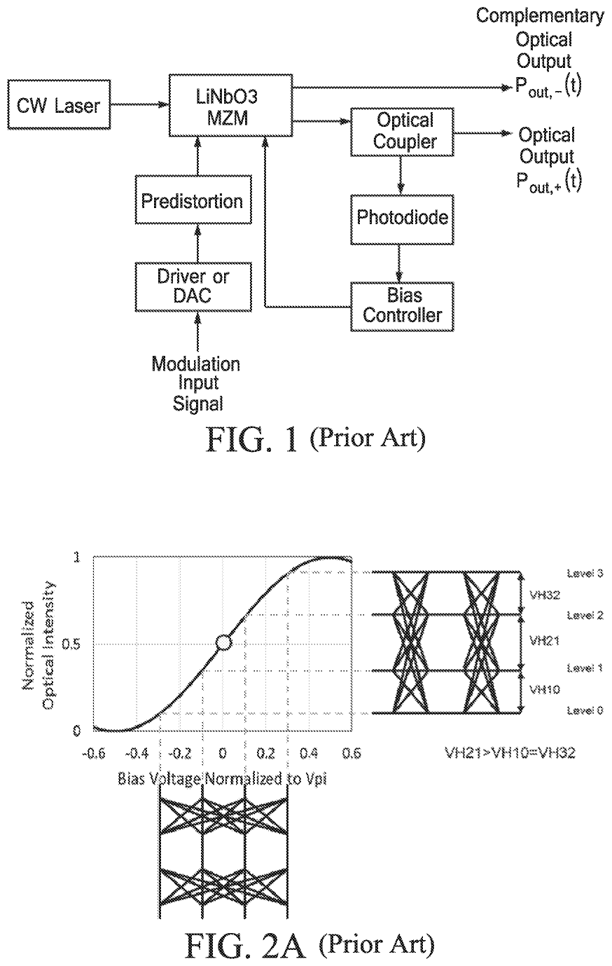

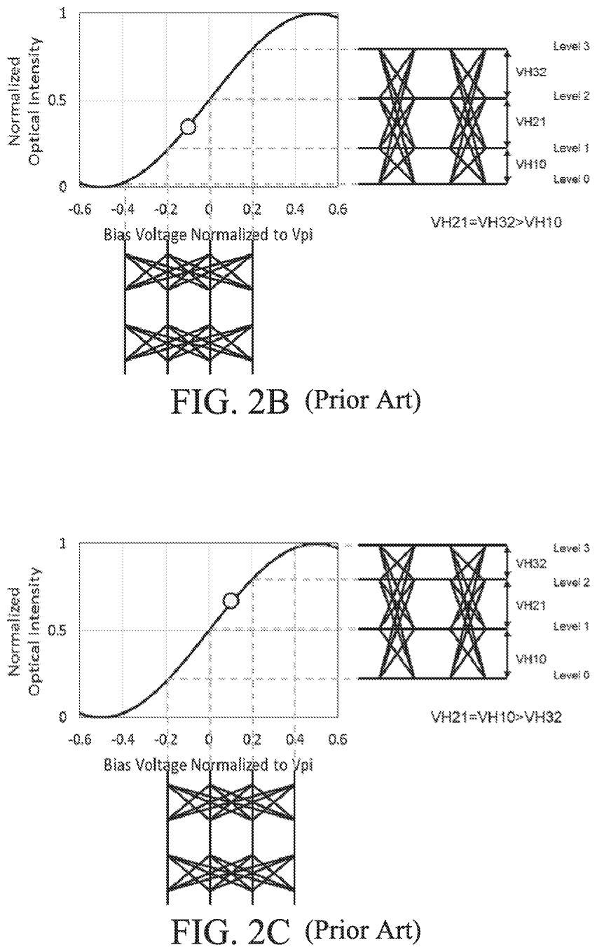

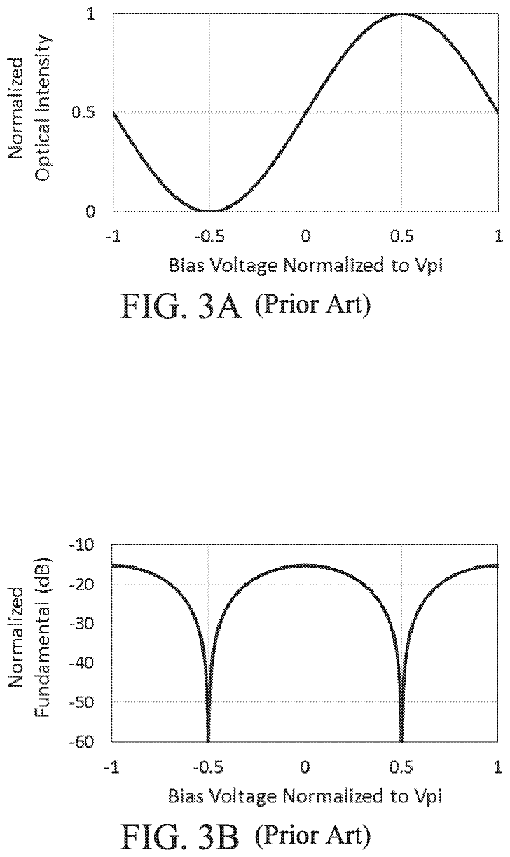

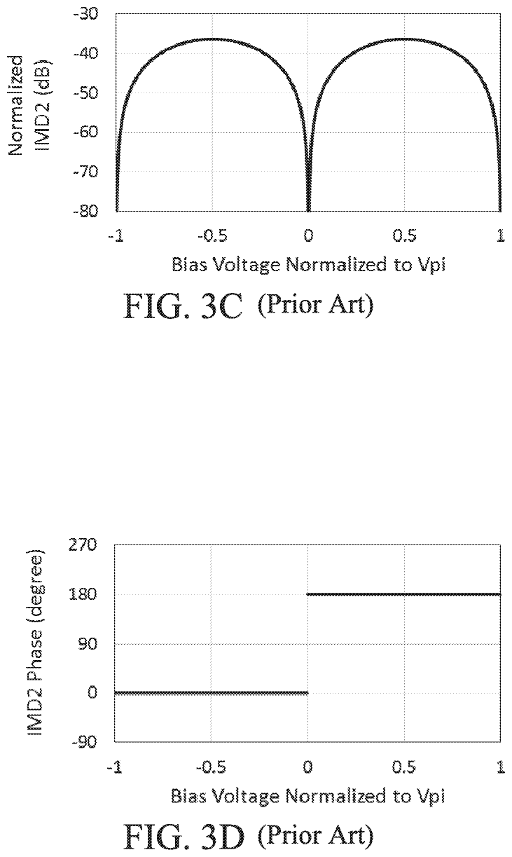

### DETAILED DESCRIPTION

The following description of the disclosure accompanies drawings, which are incorporated in and constitute a part of this specification, and illustrate embodiments of the disclosure, but the disclosure is not limited to the embodiments. In addition, the following embodiments can be properly integrated to complete another embodiment.

References to “one embodiment,” “an embodiment,” “exemplary embodiment,” “other embodiments,” “another embodiment,” etc. indicate that the embodiment(s) of the disclosure so described may include a particular feature, structure, or characteristic, but not every embodiment necessarily includes the particular feature, structure, or characteristic. Further, repeated use of the phrase “in the embodiment” does not necessarily refer to the same embodiment, although it may.

The present disclosure is directed to a dither-free bias control of a Mach-Zehnder modulator in an optical transmitter and method for operating the same. In order to make the present disclosure completely comprehensible, detailed steps and structures are provided in the following description. Obviously, implementation of the present disclosure does not limit special details known by persons skilled in the art. In addition, known structures and steps are not described in detail, so as not to limit the present disclosure unnecessarily. Preferred embodiments of the present disclosure will be described below in detail. However, in addition to the detailed description, the present disclosure may also be widely implemented in other embodiments. The scope of the present disclosure is not limited to the detailed description, and is defined by the claims.

Certain embodiments of this invention relate to the bias control methods and apparatus of the optical modulator at an arbitrary bias point without applying any amplitude modulation (AM) dithering signal. In particular, this approach can be applied to the linear operation for silicon-based MZMs which can utilize either plasma dispersion or electro-absorption effects for phase modulation. However, it should be understood that the proposed bias control scheme is not limited to the silicon-based MZMs, and it could be applied to MZMs made of other crystals and materials.

Several drawbacks limit the use of LiNbO3-based optical modulators in modern compact pluggable optical modules in terms of cost, size and power consumption. By leveraging the scalable CMOS technology, a chip-size silicon-based MZM has been proposed and developed recently. Thus, the dimension of the externally-modulated optical source could be dramatically reduced with discrete or on-chip integration of semiconductor CW Lasers and silicon-based MZMs. In addition, the half wave voltage Vc of silicon-based MZMs is much smaller than that of LiNbO3-based MZMs with the same physical size, which implies that the power consumption of the silicon-based MZM driver could be reduced accordingly. With the use of silicon-based optical components, low cost, low power consumption and compact size pluggable transceiver solutions are feasible.

One approach to develop an MZM on silicon is based on the free carrier plasma dispersion effect. One key difference between LiNbO3-based MZMs and silicon-based MZMs is the linearity performance. For LiNbO3-based MZMs, the effective refractive index change (and therefore the phase shift between two arms) is linearly proportional to the applied electrical voltage, but it is nonlinear for silicon MZMs due to the plasma dispersion effect. Details of the plasma dispersion effect are available in the article (F. Vacondio et al, A Silicon Modulator Enabling RF Over Fiber for 802.11 OFDM Signals, IEEE J. Sel. Top. Quantum Electron., vol. 16, pp. 141-148, 2010; A. M. Gutierrez et al, Analytical Model for Calculating the Nonlinear Distortion in Silicon-Based Electro-Optic Mach-Zehnder Modulators, J. Lightwave Technol., vol. 31, no. 23, pp. 3603-3613, 2013), the entirety of which is herein incorporated by reference and will not be repeated. The output optical intensity and total phase shift between two arms of the silicon-based MZMs are given by the following equations:

$$\begin{matrix} {P}_{out , +} ( t ) = \frac{{P}_{in} {L}_{a}}{2} \{ 1 + sin [ {Φ}_{total} ( t ) ] \} & ( 7 ) \\ {P}_{out , -} ( t ) = \frac{{P}_{in} {L}_{a}}{2} \{ 1 - sin [ {Φ}_{total} ( t ) ] \} & ( 8 ) \\ {Φ}_{total} ( t ) = \frac{2 π}{λ} \tilde{k} \cdot ln [ 1 + \frac{{V}_{app} ( t )}{{V}_{Bi}} ] {L}_{act} + \frac{2 π}{λ} n \cdot Δ L + \frac{2 π}{λ} ( \frac{dn}{dT} Δ T ) \cdot Δ L + {Φ}_{0} & ( 9 )\end{matrix}$$

where λ is the wavelength of a CW Laser, \tilde{k} is an empirical constant, V_{Bi} is the built-in voltage, L_{act} is the phase shifter length of an active region, n is the refractive index of the waveguide, ΔL is the length difference between two MZI arms,

$$\frac{dn}{dT}$$

is the thermo-optic coefficient, ΔT is the temperature change of the waveguide substrate supporting the MZM, and ϕ₀ is the static bias phase shift. Therefore, Equation (9) shows that the phase change is nonlinear to the applied electrical signal (Vₐₚₚ(t) in Equation (3)), as the Taylor series of natural logarithm function shown below.

$$ln ( 1 + x ) x - \frac{{x}^{2}}{2} + \frac{{x}^{3}}{3} - \frac{{x}^{4}}{4} + higher order terms \qquad ( 10 )$$

where x² is a 2nd-order NLD term, x³ is a 3rd-order NLD term, and so on. Thus, NLDs could also be generated by the plasma dispersion effect in the silicon-based MZM, and depend on the dimension and doping concentration designs in the p-n junction-embedded waveguide.

From Equation (1) for LiNbO3-based MZMs, the transfer function of the applied electrical signal to output optical intensity corresponds to the raised sinusoidal function. However, by substituting Equation (9) into Equation (7), the transfer function for silicon-based MZMs is no longer a sinusoidal relationship. Obviously, unlike the LiNbO3-based MZMs, the quadrature points of the silicon-based MZMs are not the best operation point for minimizing even-order NLDs, and additionally NLDs at the output of the silicon-based MZMs are generated by the interaction of MZI-induced raised sinusoidal functions (Equation (7)) and plasma dispersion-induced logarithm functions (Equation(9)).

Thus, the present disclosure proposes to slightly offset the bias point of the silicon-based MZM from the half power points, and it is anticipated that the MZI-induced even-order NLDs can be generated to cancel the plasma dispersion-induced even-order NLDs. In this operation scenario, those LiNbO3-based MZM bias control methods seeking quadrature points or half power points are not adapted, and an MZM bias controlling module, which can arbitrarily adjust and lock in the bias point, is needed for silicon-based MZMs.

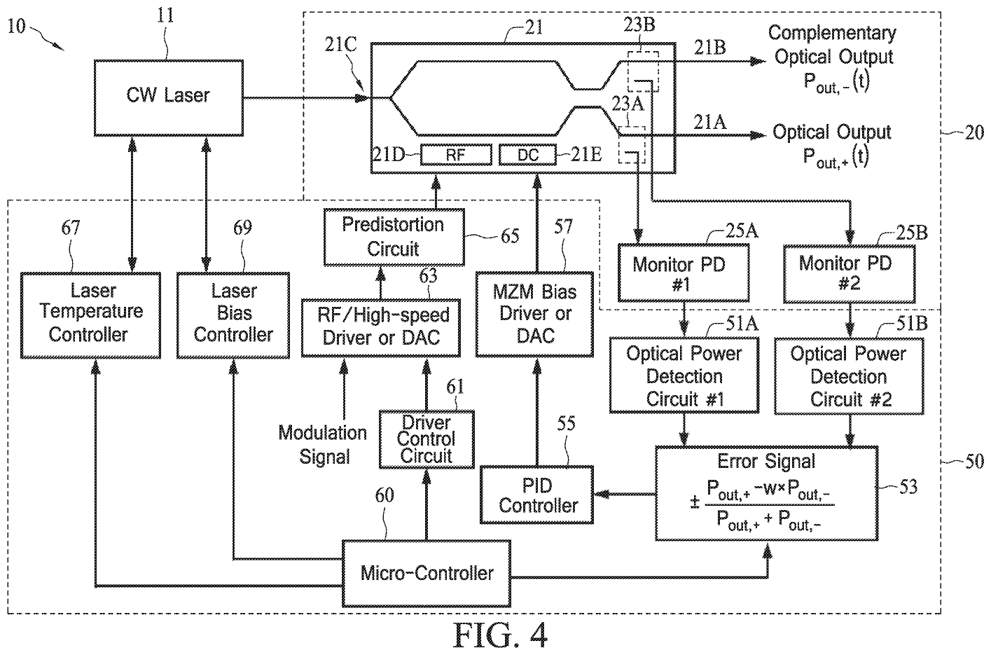

FIG. 4 illustrates an optical transmitter 10 in accordance with various embodiments of the present disclosure. In some embodiments, the optical transmitter 10 comprises a laser source 11 to produce an optical carrier signal; an optical device 20 comprising an optical modulator 21 to modulate an RF input signal onto the optical carrier signal and provide RF modulated optical signals on a first output 21A and a second output 21B; and a controlling module 50 which takes into consideration a feedback signal (error signal) to control the optical modulator 20 operating substantially not at a quadrature point of a transfer characteristic of the optical modulator 21; wherein the controlling module 50 generates the feedback signal while taking into consideration a power of the RF modulated optical signal on the first output 21A, a power of the RF modulated optical signal on the second output 21B, and a bias offset.

In some embodiments, the laser source 11 is a continuous wave (CW) laser selected from a group consisting of a distributed feedback (DFB) Laser, an external cavity Laser (ECL) or a tunable Laser, which generates an optical beam at the output. In some embodiments, the optical wavelength could be selected per communication applications or standards, such as O band, C band, L band, or others.

In some embodiments, the optical device 20 comprises a first photodetector 25A to monitor the RF modulated optical signal on the first output 21A via a first directional coupler 23A; and a second photodetector 25B to monitor the RF modulated optical signal on the second output 21B via a second directional coupler 23B. In some embodiments, the optical modulator 21 is a silicon-based dual-optical-output MZM with two power monitoring photodiodes (photodetector 25A and photodetector 25B) at the two output ports which detect optical power taped out from the output ports by, for example, directional couplers (directional coupler 23A and directional coupler 23B). Such power monitoring structures could be either monolithically integrated on the same silicon chip or implemented through external discrete optical directional couplers and monitor photodiodes (PDs) outside the silicon chip.

In some embodiments, the controlling module 50 comprises two optical power detection circuits 51A and 51B, one feedback signal (error signal) generating circuit 53, one PID (proportional-integral-derivative) controller 55, one micro-controller 60, one MZM bias driver or digital-to-analog converter (DAC) 57, one driver control circuit 61, one RF/High-speed driver or DAC for the modulation signal 63, one predistortion circuit 65, one laser temperature controller 67 and one Laser bias controller 69. In some embodiments, the two optical power detection circuits 51A and 51B are implemented to detect the optical power levels, and they could be composed of the trans-impedance amplifier or the logarithmic amplifier, which converts the detected photocurrent into the voltage level.

In some embodiments, the optical modulator 21 comprises an optical input 21C connected to the optical output of the laser source 11, an RF electrode 21D configured to receive the RF or high-speed electrical modulating signal, and a DC electrode 21E configured to adjust the MZM bias point; wherein the two optical outputs 21A and 21B (P_{out,+}(t) and P_{out,-}(t)) have 180-degree out of phase with each other. In some embodiments, the two integrated or discrete monitor PDs (photodetector 25A and photodetector 25B) are configured to detect the optical power levels at two MZM optical outputs 21A and 21B through the two optical directional couplers (directional coupler 23A and directional coupler 23B).

In some embodiments, the proposed dither-free control scheme could operate the MZM at an arbitrary point. This control scheme includes the use of two optical power detections, and the normalized weighting difference between the optical power levels at two optical outputs (P_{out,+}(t) and P_{out,-}(t)) is used as an error signal for negative feedback control. The updated MZM bias voltage will be generated by the MZM bias driver or DAC for the negative feedback control loop over the environmental variations. The error signal will be followed by a PID controller. The PID controller continuously computes an error value as the difference and the direction between a measured result and a desired setpoint, and attempts to minimize the error signal over time by adjusting the control variables, such as the DC bias voltage V_{DC}. More control variables will be discussed later.

In some embodiments, the error signal generating circuit 53 and the PID controller 55 could be implemented by digital processing or analog circuitry. For the digital approach, two detected voltages from two optical power detection circuits are digitized by the analog-to-digital converters (ADCs) with sufficient resolutions, and thus the proposed error signal and PID control signal could be calculated in the micro-controller 60. For the analog approach, the discrete or integrated divider together with operational amplifiers could be used to implement the proposed error function with the normalized weighting difference between the optical power levels, and additionally the weighting factor and slope sign of the MZM transfer function could be adjusted by the micro-controller 60.

In some embodiments, the controlling module 50 also includes a predistortion circuit 65 to further linearize the optical externally-modulated transmitter by partially or completely cancelling the odd-order NLDs generated by the optical modulator 21, and it is implemented between the RF/high-speed driver (or DAC) 63 of the applied electrical modulating signal and the RF electrode 21D of the optical modulator 21. In addition, it is well-known that either automatic power control (APC) or automatic temperature control (ATC) could be implemented for a CW Laser to keep optical output power and wavelength stable.

In some embodiments, the present disclosure provides a dither-free control scheme to operate the silicon-based MZM in the most linear region. This control scheme includes the use of two optical power detections, and the normalized weighting difference between the optical power levels at two optical outputs (P_{out,+}(t) and P_{out,-}(t)) is used as an error signal for negative feedback control, which continuously adjusts and locks in the bias point of the silicon-based MZM to the desired bias phase for minimum even-order NLDs over the environment variations. In other words, the normalized weighting difference is used to offset the bias point (or bias phase) away from the half power points, while the half power points are not the best bias points due to the plasma dispersion effect in silicon-based MZMs. The proposed error signals to operate with the positive and negative slopes of the electric-to-optical (FO) transfer function at the output port are expressed, respectively, as follows:

$$\begin{matrix}Error Signal ( t ) = \frac{{P}_{out , +} ( t ) - w \times {P}_{out , -} ( t )}{{P}_{out , +} ( t ) + {P}_{out , -} ( t )} = \frac{( 1 - w ) + ( 1 + w ) sin [ {Φ}_{total} ( t ) ]}{2} for positive slope & ( 11 ) \\ Error Signal ( t ) = - \frac{{P}_{out , +} ( t ) - w \times {P}_{out , -} ( t )}{{P}_{out , +} ( t ) + {P}_{out , -} ( t )} = - \frac{( 1 - w ) + ( 1 + w ) sin [ {Φ}_{total} ( t ) ]}{2} for negative slope & ( 12 )\end{matrix}$$

where w is the weighting factor for the optical power difference at two optical outputs, which allows adjusting the bias point away from the half power points. The operation point can be arbitrarily chosen by setting the specific weighting difference to minimize the 2nd-order NLDs.

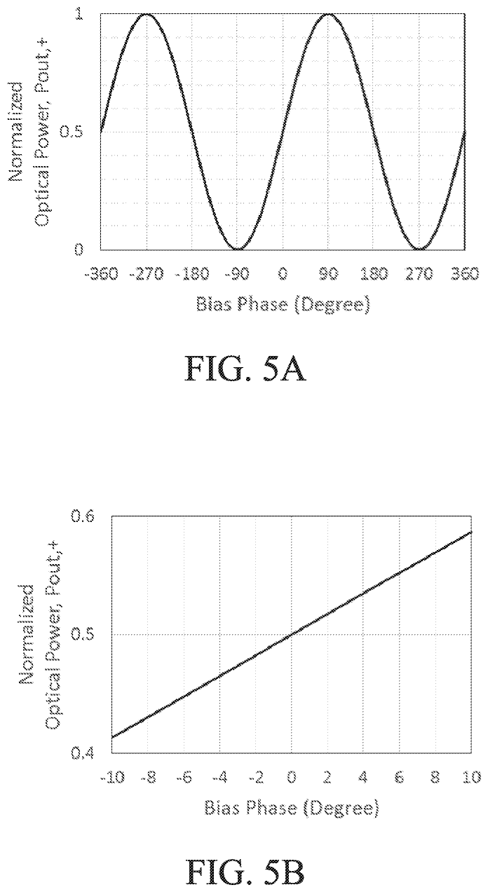

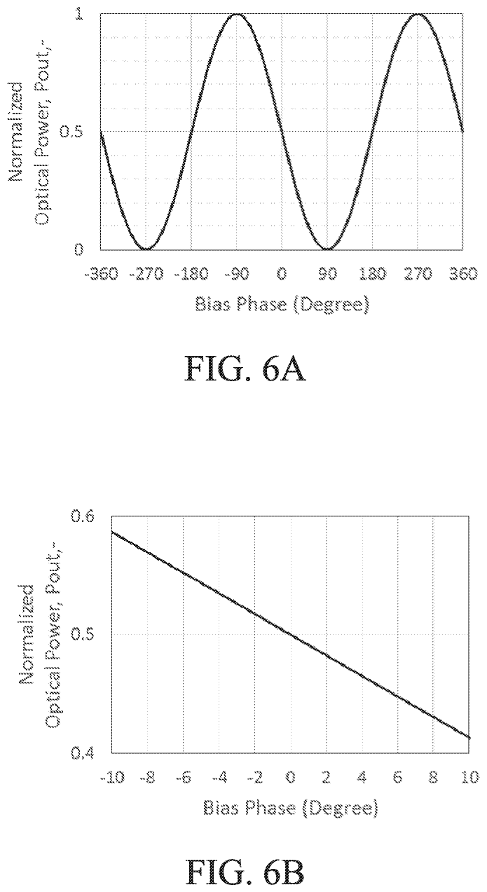

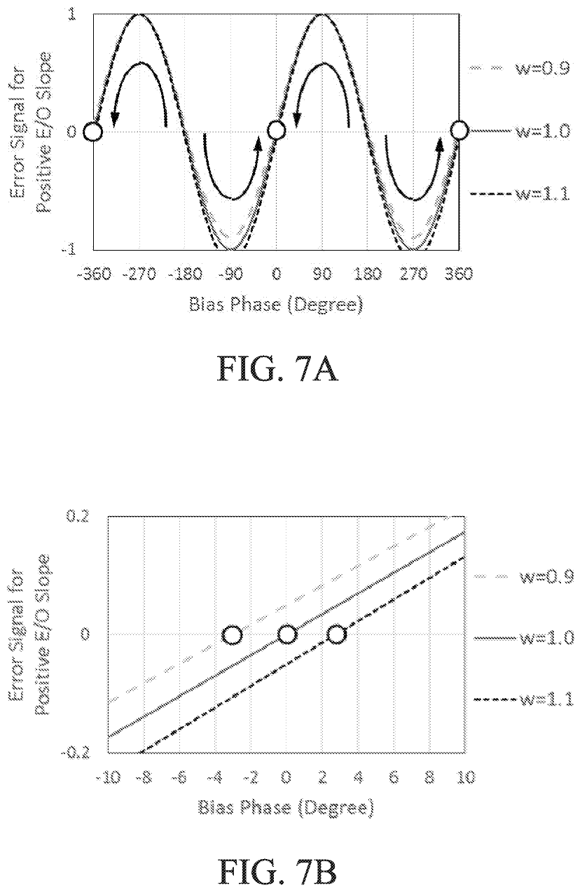

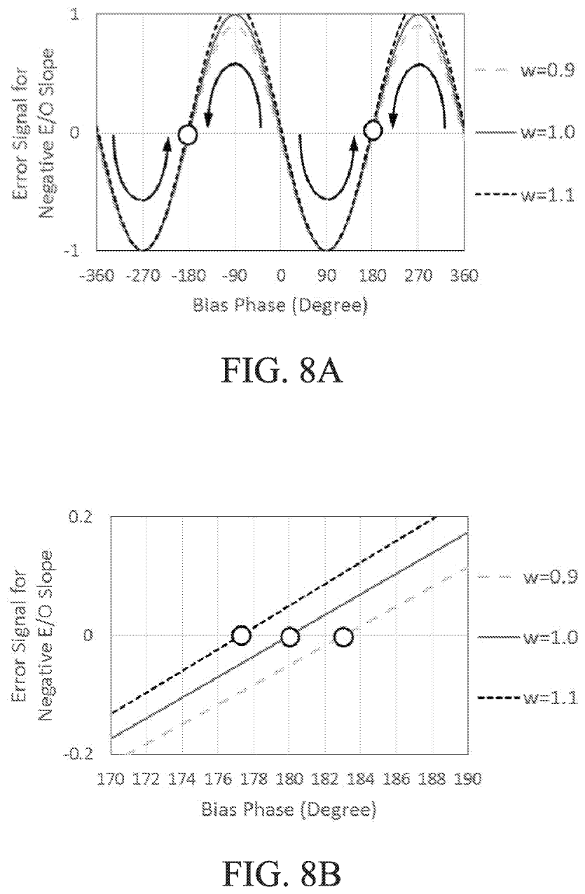

FIG. 5A is the optical power intensity at the first output 21A (constructive port) as a function of the bias phase, FIG. 6A is the optical power intensity at the second output 21B (complementary port or destructive port) as a function of the bias phase, and FIG. 5B and FIG. 6B are close-up views of FIG. 5A and FIG. 6A, respectively. FIG. 7A is the corresponding error signal of the proposed bias control for the positive FO slopes of the first output 21A, FIG. 8A is the corresponding error signal of the proposed bias control for the negative FO slopes of the first output 21A, and FIG. 7B and FIG. 8B are close-up views of FIG. 7A and FIG. 8A, respectively. While the equal difference of two optical powers is considered, i.e. w=1, the zero of an error signal occurs at quadrature points (bias phase of mπ, where m belongs to integers) and half power points (normalized optical intensity of 0.5). As shown in FIG. 7B, the zero-crossing point of an error signal could be shifted to the bias phase of around 2.7 degrees and around −3 degrees, respectively, by setting the weighting factor to 1.1 and 0.9, for example. The error signal for the negative E/O slopes of the first output 21A could be found in FIG. 8B. Note that the hollow circles shown in FIG. 7A and FIG. 8A are the desired bias targets for different exemplary error signals.

Considering the error signals in Equation (11) and (12) are equal to zero, the zero-crossing point of the error signal for a MZM bias control loop is as follows:

$${Φ}_{total , zero - crossing} = {sin}^{- 1} ( \frac{w - 1}{w + 1} ) in radian \\ where {sin}^{- 1} θ = θ + \frac{1}{6} {θ}^{3} + \frac{3}{40} {θ}^{5} + … ≅ θ , for θ << 1. \qquad ( 13 )$$

Again, the proposed dither-free control scheme is designed to slightly offset the bias point of the silicon-based MZM from the half power points, and it is anticipated that the MZI-induced even-order NLDs can be generated to cancel the plasma dispersion-induced even-order NLDs. However, plasma dispersion-induced NLDs depend on the material and design of silicon-based waveguides. So, the proposed control scheme applies the electrical signals into the silicon-based MZM, and measures the resultant NLDs or total harmonic distortion (THD) over various bias offsets. Consequently, the zero-crossing point of the error signal for the proposed MZM bias control scheme is set to align with the measured bias offset in order to minimize NLDs or THDs, i.e., ϕ_{total,zero-crossing}=ϕ_{total,minNLD}. For slight offset from quadrature points, the weighting factor for the optical power difference at two optical outputs as a function of the measured bias offset for minimum NLDs, ϕ_{total,minNLD} in radian, is given by the following equation:

$$w ≅ \frac{1 + {Φ}_{total , minNLD}}{1 - {Φ}_{total , minNLD}} \qquad ( 14 )$$

In reference to Equation (9), the total phase shift between two arms of the silicon-based MZM is related to several parameters, including a) the wavelength (λ) of the CW Laser, b) the DC term of the applied electrical signal of Vₐₚₚ (i.e., V_{DC} in Equation (3)), and c) the temperature change of the waveguide substrate ΔT. These parameters could be used as the control variables for the feedback control loop to reach zero error, i.e., ϕₜₒₜₐₗ=ϕ_{total,zero-crossing}, and thus the bias offset for minimizing NLDs or THDs, i.e., ϕₜₒₜₐₗ=ϕ_{total,minNLD}.

In some embodiments, the controlling module 50 controls the wavelength of the optical carrier signal from the laser source 11; for example, controlling the temperature of the laser source 11 or the bias current of the laser source 11, i.e., controlling the phase of the RF modulated optical signal propagating in the optical modulator 21 by changing the wavelength of the optical carrier signal according to Equation (9). The wavelength of the CW Laser could be used as a control variable to adjust the MZM bias by changing either the forward bias current applied into the CW Laser or the temperature of the Laser chip. Details of the wavelength control of the CW Laser are available in the article (Nursidik Yulianto, Bambang Widiyatmoko, Purnomo Sidi Priambodo, Temperature Effect towards DFB Laser Wavelength on Microwave Generation Based on Two Optical Wave Mixing, International Journal of Optoelectronic Engineering, Vol. 5 No. 2, 2015, pp. 21-27. doi: 10.5923/j.ijoe.20150502.01.), the entirety of which is herein incorporated by reference.

In some embodiments, the controlling module 50 controls the bias voltage of the optical modulator 21 via the DC electrode 21E on the optical modulator 21, i.e., controlling the phase of the RF modulated optical signal propagating in the optical modulator 21 by changing the bias voltage of the optical modulator 21 according to Equation (9). Applying the DC voltage into the MZM is a common control variable to adjust and lock in the bias point of an optical intensity modulator. If the individual electrode is reserved for RF/high-speed signals and a DC bias, the MZM bias driver or DAC 57 can be connected to the DC electrode 21E of the MZM directly, as shown in FIG. 4. In case there is only one electrode for both the RF/high-speed signals and DC bias (i.e. DC electrode is not available in the design), the MZM bias driver or DAC 57 should be connected to the RF electrode 21D through one bias-tee (not shown in FIG. 4) inserted in between.

In some embodiments, the controlling module 50 controls the temperature of the optical modulator 21 via a thermoelectric cooler controller, i.e., controlling the phase of the RF modulated optical signal propagating in the optical modulator 21 by changing the temperature of the optical modulator 21 according to Equation (9). Changing the temperature of the silicon substrate is also an option to adjust the MZM bias point. However, more care should be taken for the monolithic integrated design of the CW Laser together with the silicon-based MZM. While the thermoelectric cooler (TEC) controller works to change the temperature of the silicon substrate for MZM bias adjustment, the temperature of the Laser chip and thus the optical wavelength could be varied accordingly.

Generally, a TEC is a device where current flow through the device will heat one side of the device while cooling the other side of the device. The side that is heated and the side that is cooled are controlled by the direction of the current flow. Consequently, current flow in one direction will heat a first side while the same first side will be cooled when the current flow is reversed. Thus, by varying the current direction, a TEC connected to a laser or optical modulator may be used to either heat or cool the laser or optical modulator to maintain a constant operating temperature.

The proposed dither-free MZM bias control scheme based on the normalized weighting optical power difference could adjust and lock in the MZM bias on both the positive and negative E/O slopes by using the error signals in Equation (11) and (12), respectively. The polarity of the optical intensity variation is the same as that of the applied electrical signal for the operation on the positive E/O slopes, while they are 180-degree out of phase for the operation on the negative E/O slopes. Therefore, if keeping the same polarity is necessary, the micro-controller 60 could send a polarity inversion command to the RF/High-speed driver or DAC 63 through the driver control circuit 61, as shown in FIG. 4, for negative E/O slopes.

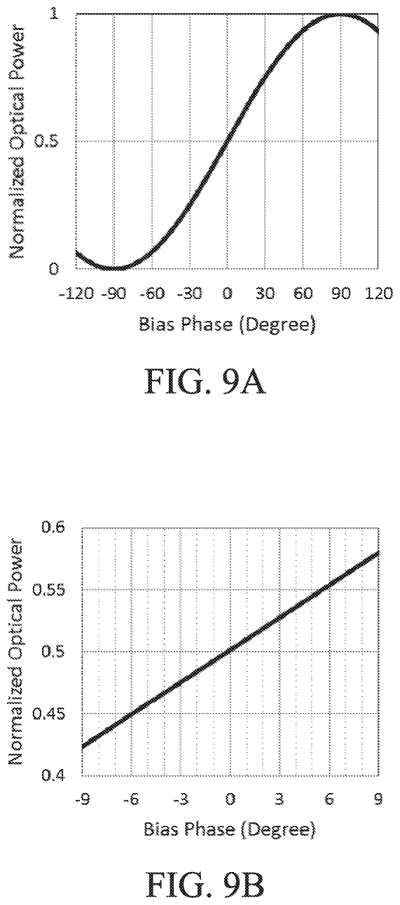

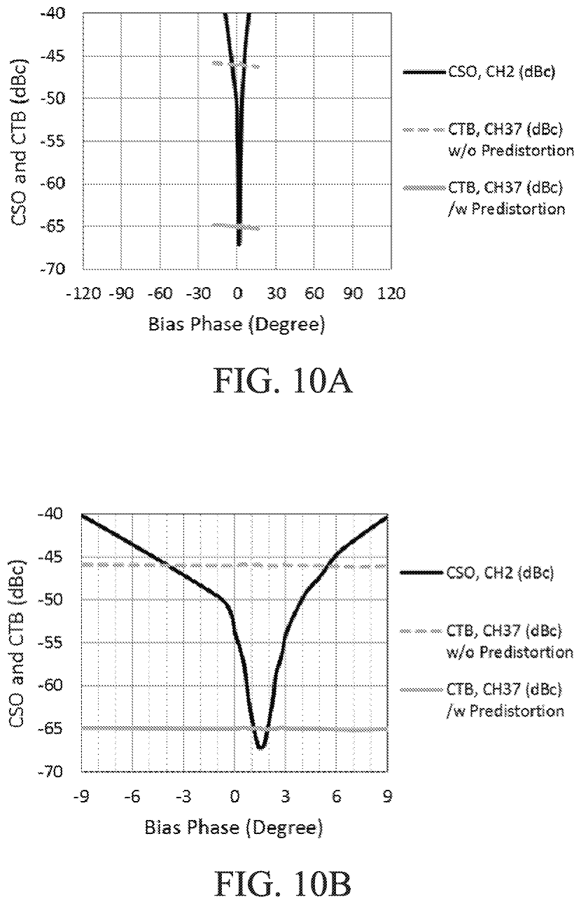

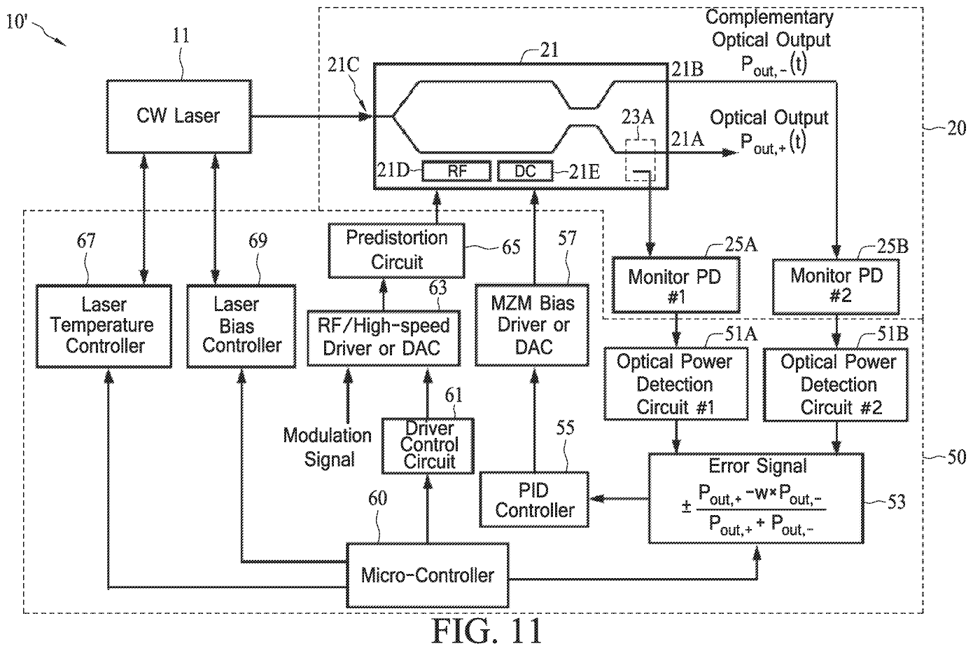

FIG. 9A and FIG. 10A are the measured optical intensity, CSO and CTB as a function of the bias phase, while CATV 78 analog channels are applied into the silicon-based MZM without and with the traditional 3rd-order predistortion, and FIG. 9B and FIG. 10B are close-up views of FIG. 9A and FIG. 10A, respectively. Note that the CSO is the power ratio of 2nd-order NLDs to the signal carrier, and the CTB is the power ratio of 3rd-order NLDs to the signal carrier. Around the half power point (normalized optical power of 0.5), the CSO varies sharply due to the asymmetric bias operation, while the CTB remains almost constant. Referring to FIG. 10B, as the silicon-based MZM is biased at zero degrees, i.e., its quadrature point, the corresponding CSO is about −55 dBc, which originates from the plasma dispersion-induced even-order NLDs because there is no Mach-Zehnder interference (MZI)-induced even-order NLDs when the MZM is biased at its quadrature point. Offsetting the bias point of the silicon-based MZM from its quadrature points intentionally results in the combination of the Mach-Zehnder interference (MZI)-induced even-order NLDs and the plasma dispersion-induced even-order NLDs.

Note that the bias phase of the silicon-based MZM should be shifted away from its quadrature point by around 1.5 degrees to reach the best CSO performance. The typical target specifications of CSO and CTB are smaller than −60 dBc for the latest CATV/FTTH (fiber to the home) requirements. With the proposed MZM bias scheme and the traditional predistortion design, the silicon-based MZM is verified to meet the CATV/FTTH specifications. In some embodiments, the controlling module 50 generates the weighting factor by using the bias offset for minimizing NLDs (CSO) in Equation (14), which means taking into consideration Mach-Zehnder interference-induced even-order nonlinear distortions and plasma dispersion-induced even-order nonlinear distortions.

FIG. 11 illustrates an optical transmitter 10′ in accordance with various embodiments of the present disclosure. Compared with the optical transmitter 10 in FIG. 4 using two directional couplers 23A and 23B to direct a portion of the optical power at the two MZM optical outputs 21A and 21B to the two monitor PDs (photodetector 25A and photodetector 25B) respectively, the optical transmitter 10′ in FIG. 11 uses one optical directional coupler 23A to direct a portion of the optical power from the first output 21A to the first photodetector 25A, while the optical power on the second output 21B is directed to the second photodetector 25B without using a directional coupler. In the case that optical fiber redundancy is not considered in the access network, the complementary optical output (second output 21B) of a dual-optical-output MZM is not used for signal transmission. The optical power level of the complementary optical output could be detected directly, which saves space to implement an optical directional coupler.

The present disclosure provides a dither-free bias control of the optical modulator for the externally-modulated transmitter with the silicon-based MZM, while the nonlinear distortions (NLDs) are generated by the plasma dispersion effect of the silicon-based MZM. The present disclosure proposes to intentionally offset the bias point of the silicon-based MZM from its quadrature points, and therefore the Mach-Zehnder interference (MZI)-induced even-order NLDs can be generated to cancel the plasma dispersion-induced even-order NLDs.

In addition, the dither-free MZM bias control is also proposed to arbitrarily adjust and lock in the bias point of an optical modulator so an optical transmitter with the integrated silicon-based MZM could reach the best even-order NLDs by offsetting from the quadrature points. This proposed dither-free MZM bias control scheme ensures the linear operation of an optical MZM for various legacy and potentially promising analog/digital optical transmission systems, such as CATV subcarrier multiplexed lightwave systems, radio-over-fiber applications, >100 Gb/s optical transport with discrete multi-tone (DMT) or 4-level pulse amplitude modulation (PAM4), and so on.

Moreover, while the proposed dither-free control scheme could arbitrarily adjust and lock in the bias of MZM, the receiver sensitivity could be optimized by using such a bias control scheme to adjust the extinction ratio of multi-level signals, such as binary NRZ, PAM4, etc.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An optical transmitter, comprising:
a laser source to produce an optical carrier signal;
an optical modulator to modulate an radio frequency (RF) input signal onto the optical carrier signal and provide RF modulated optical signals on a first output and a second output; and
a controlling module which takes into consideration a feedback signal to control the optical modulator operating substantially not at a quadrature point of a transfer characteristic of the optical modulator,
wherein the controlling module generates the feedback signal while taking into consideration a first power level of the RF modulated optical signal on the first output, a second power level of the RF modulated optical signal on the second output, and a weighting difference between the first optical power level and the second power level.

2. The optical transmitter of claim 1, wherein the controlling module generates the feedback signal by using an expression:
$$feedback signal ( t ) = \frac{{P}_{out , +} ( t ) - w \times {P}_{out , -} ( t )}{{P}_{out , +} ( t ) + {P}_{out , -} ( t )}$$
wherein P_{out,+}(t) represents the first power level, P_{out,-}(t) represents the second power level, and w represents a weighting factor.

3. The optical transmitter of claim 2, wherein the controlling module generates the weighting difference by using an expression:
$$w ≅ \frac{1 + {Φ}_{total , minNLD}}{1 - {Φ}_{total , minNLD}}$$
wherein ϕ_{total,minNLD} represents a bias phase substantially having a minimum even-order nonlinear distortion.

4. The optical transmitter of claim 1, wherein the controlling module generates the weighting difference while taking into consideration Mach-Zehnder interference-induced even-order nonlinear distortions and plasma dispersion-induced even-order nonlinear distortions.

5. The optical transmitter of claim 1, wherein the controlling module controls a phase of the RF modulated optical signal propagating in the optical modulator via an electrode on the optical modulator.

6. The optical transmitter of claim 1, wherein the controlling module controls a temperature of the optical modulator via a thermoelectric cooler controller.

7. The optical transmitter of claim 1, wherein the controlling module controls a bias voltage of the optical modulator via an electrode on the optical modulator.

8. The optical transmitter of claim 1, wherein the controlling module controls a wavelength of the optical carrier signal from the laser source.

9. The optical transmitter of claim 1, wherein the controlling module controls a temperature of the laser source.

10. The optical transmitter of claim 1, wherein the controlling module controls a bias current of the laser source.

11. The optical transmitter of claim 1, wherein the optical modulator is a silicon-based dual-optical-output modulator with two power monitoring photodiodes that detect the first power level and the second power level via two directional couplers; wherein the optical modulator, the two power monitoring photodiodes and the two directional couplers are integrally formed on a single chip.

12. The optical transmitter of claim 11, wherein the optical modulator is a silicon-based dual-optical-output modulator with first power monitoring photodiode that detect the first power level via a directional coupler, and second power monitoring photodiode that detect the second power level without using a directional coupler, wherein the optical modulator, the two power monitoring photodiodes and the directional coupler are integrally formed on a single chip.

13. A method for operating an optical transmitter, comprising the steps of:
producing an optical carrier signal;
modulating an RF input signal onto the optical carrier signal and providing RF modulated optical signals on a first output and a second output;
generating a feedback signal while taking into consideration a first power level of the RF modulated optical signal on the first output, a second power level of the RF modulated optical signal on the second output, and a weighting difference between the first optical power level and the second power level; and
controlling the optical modulator operating substantially not at a quadrature point of a transfer characteristic of the optical modulator while taking into consideration the feedback signal.

14. The method for operating an optical transmitter of claim 13, wherein the step of generating a feedback signal is performed by using an expression:
$$feedback signal ( t ) = \frac{{P}_{out , +} ( t ) - w \times {P}_{out , -} ( t )}{{P}_{out , +} ( t ) + {P}_{out , -} ( t )}$$
wherein P_{out,+}(t) represents the first power level, P_{out,-}(t) represents the second power level, and w represents a weighting factor.

15. The method for operating an optical transmitter of claim 14, wherein the weighting factor is set by using an expression:
$$w ≅ \frac{1 + {Φ}_{total , minNLD}}{1 - {Φ}_{total , minNLD}}$$
wherein ϕ_{total, minNLD} represents a bias phase substantially having a minimum even-order nonlinear distortion.

16. The method for operating an optical transmitter of claim 13, wherein the weighting difference is generated while taking into consideration Mach-Zehnder interference-induced even-order nonlinear distortions and plasma dispersion-induced even-order nonlinear distortions.

17. The method for operating an optical transmitter of claim 13, wherein the step of controlling the power of the RF modulated optical signal is performed to control a phase of the RF modulated optical signal propagating in the optical modulator.

18. The method for operating an optical transmitter of claim 13, wherein the step of controlling the optical modulator operating substantially not at a quadrature point is performed by controlling a temperature of the optical modulator.

19. The method for operating an optical transmitter of claim 13, wherein the step of controlling the optical modulator operating substantially not at a quadrature point is performed by controlling a bias voltage of the optical modulator.

20. The method for operating an optical transmitter of claim 13, wherein the step of controlling the optical modulator operating substantially not at a quadrature point is performed by controlling a wavelength of the optical carrier signal.

21. (canceled)

22. (canceled)
